(19) United States
(12) Patent Application Publication
(10) Pub. No.: US 2013/0045823 A1
(43) Pub. Date: Feb. 21, 2013

(54) Reinforced Wooden Baseball Bat and Method

(71) Applicant: Robert Earl Sublett, SR., Sarasota, FL (US)

(72) Inventor: Robert Earl Sublett, SR., Sarasota, FL (US)

(21) Appl. No.: 13/371,450

(22) Filed: Feb. 12, 2012

Related U.S. Application Data
(60) Provisional application No. 61/443,411, filed on Feb. 16, 2011.

(51) Int. Cl. A63B 59/06; B32B 37/22

(52) U.S. Cl. 473/564; 156/161

(57) ABSTRACT

A reinforced wooden baseball bat is provided which includes a wooden bat body having a handle portion, a barrel portion, and a tapered portion in between, connecting the handle to the barrel, the handle diameter being smaller than the barrel diameter; this reinforced bat further includes one or more applications of wraps of high-strength and low weight threads of para-aramid fiber (Kevlar), carbon fiber thread or other high-strength and lightweight thread, wound, under tension, onto the circumference of said bat, with circumferential turns of said high-strength thread, applied and bonded to the wood bat, at locations along the length of the bat, where it is calculated that said bat will be made the strongest thereby. The location(s) along the bat, number of wraps, thread diameter, thread tension and the number of turns of thread per wrap, are calculated to maximally strengthen each individual bat, considering its characteristics.

### CROSS REFERENCES TO RELATED APPLICATIONS

This application claims the priority benefit of U.S. Provisional Patent Application, Ser. No. 61/443,411, filed on Feb. 16, 2011, by Robert Earl Sublett, Sr., entitled “Reinforced Wooden Baseball Bat and Method,” the subject matter contained therein being incorporated by reference.

### TITLE OF THE INVENTION

Reinforced Wooden Baseball Bat and Method

### FEDERALLY SPONSORED RESEARCH

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK

Not Applicable

### BACKGROUND OF THE INVENTION

Technical Field

The present invention relates to reinforced wooden baseball bats and similar types of sports equipment, and a method to reinforce all wooden baseball bats. More particularly, the present invention relates to a wooden baseball bat having one or more circumferential reinforcing wraps of one or more turns of tensioned, high-strength string or thread, made from para-aramid (Kevlar), carbon fiber or other high-strength fiber, applied and bonded onto said wood bat at a point or multiple points along the length of the wood bat, where calculations, testing and experience show that said wrap(s) will produce the greatest improvement in bat strength. The descriptive terms “wood” and “wooden” are, for this application, considered equivalent, as are the terms “string” and “thread,” which, for the present invention, each refers generally to a length of material having an approximate diameter between 1 to 30 thousandths of an inch (0.001 inch to 0.030 inch).

Background Art

The purpose of this invention is to strengthen wood baseball bats to lessen their chance of breakage during use, while making no changes to the wood of the bat, and, further, to accomplish this strengthening with the smallest possible amount of added weight or bulk. The advent of high-strength fibers, such as para-aramids (Kevlar) and carbon fiber filaments has enabled their use as a strengthening wrap around wood bats. The para-aramid thread itself is very strong (5 times stronger than steel), lightweight and very small.

In addition, the high strength, low weight and small size of this thread allows this present invention to strengthen wood baseball bats significantly with very little added weight or bulk, and can be realistically considered for adoption in all venues where wood bats are used, including Major League Baseball (MLB), to strengthen wood bats, which adoption is one object here, because this present invention and method is the least invasive of all proposals for the increase in strength derived. Also, it does not produce a super bat; it only allows the bat to perform to its natural capability with less potential for breakage. A super bat is defined here as a bat whose performance is better than a wooden bat, such as most metal alloy bats.

The closest prior art to the present invention of reinforced wooden baseball bats is U.S. Pat. No. 7,448,971, Smalley, 2008, 473/564, Reinforced Wooden Baseball Bat, uses circumferential grooves, cut into the bat at certain points along the length of the bat, said grooves then filled with a polymer band, the ends of the band fused and, which band, in the groove, is finally covered with a bonding agent. The weakness of this strengthening method is the grooves cut into the bat. These cuts in the batwood, under stress of a high-speed ball/bat collision, would become the loci of stress forces, potentially causing the wood to fail at the point of the grooves, either breaking or splitting. The encircling bands, too, are suspect, as they are not tensioned and may apply only minimal constraining force against breakage to that area of the bat. The force of a ball/bat collision has been calculated to be over 4 tons (8,000 lbs.) of instantaneous force, averaged to over 2 tons (4,000 lbs.) for approximately 0.7 (7 tenths) of one millisecond.

Another method of strengthening wood bats is revealed in U.S. Pat. No. 6,238,309, Sample, 2001, Break Resistant Ball Bat and U.S. Pat. No: 6,036,610, Lewark, 2000, where a fiberglass or composite overlay or sleeve is bonded to the handle area, strengthening that area of the bat. Other strengthening methods are U.S. Pat. No. 6,139,451, Hillerich, 2000, for a composite which completely covers the wood bat. Still others, such as U.S. patent application No. 2007/0232422 A1, Chang, Jung-Shih, for a wood bat with a reinforced bamboo core, and U.S. application No. 2010/0292035 A1, Huang, for a Safety Baseball Bat with a metal rod through the center.

None of the above-mentioned patents or applications embodies a solution to the bat breakage problem because none offers a solution without creating a “super bat,” or is a solution which changes the bat too radically.

The handle of any bat is both victim and perpetrator in that it, being smaller in diameter than the barrel portion, receives the most flexing as it absorbs the forces of the ball impacting a certain point on the bat, flexing the bat and causing the bat to begin to vibrate. The area of a 2.61 inch diameter bat barrel is 7.75 times as large as the area of a 15/16^{th} inch diameter bat handle.

### BRIEF SUMMARY OF THE INVENTION

Description

In the present invention, a circumferential wrap of one or more turns of high-strength string or thread, tightly wrapped and bonded, is applied to a wood bat at one or more locations along the length of the bat. This wrap will serve to keep the wood from separating near the wrapped point(s) when a frontal or shear force is applied, such as when the bat impacts a pitched baseball, at various places along the length of the bat.

This wrap is a viable solution to the wood bat failure problem which has spread across baseball venues, including and especially MLB, because the wrap and the bonding agent are extremely light and almost imperceptible, and are applied to an otherwise unchanged standard wooden bat, either new or used. Otherwise, the bat is not modified or changed in any way. If this method is adopted, MLB will not need to change any other rule. The wrap does not create a “super bat.”

The total amount of the thread and the bonding agent used have almost imperceptible weight, and, for its strengthening benefit, is the only present solution that, while strengthening the bat against breakage, adds almost no weight or bulk to the bat and, therefore, this wrap process could possibly be approved by baseball venues, and especially the Major League Baseball Rules Committee, for use in MLB games to reduce wood bat breakages and reduce injuries to players and fans.

Although the cost of bats in MLB is staggering—over $20 million per year—the potential cost of injury to players or fans dwarfs the cost of the bats. Even now, lawsuits valued in the millions of dollars are being prosecuted by attorneys for the players and fans who have already been injured by flying pieces of broken bats.

This present invention can be particularly helpful for the bat breakage problem which is now troubling Major League Baseball (MLB). However, Major League Baseball wants to keep wooden bats just as they are and as they have been. There are over 160 years of baseball history and batting statistics that are potentially in jeopardy over the advent of a “super-bat” (the first baseball game was played in 1846.) Since then wood bats have gotten shorter and lighter, but are essentially the same today as in 1869.

Metal alloy bats are truly “super bats.” So, if at all possible, MLB wants to avoid changing to alloy bats. They are hoping that Ash and Maple bats, because of the recent rule changes, will prove to be adequate. Due to the tighter rules improving the slope of grain (SOG), the wood bats made after the new rules will be statistically 300% stronger than the weakest of the old-rules bats with a SOG of 1:6. So, wood bat failures caused by high slope of grain will be greatly reduced.

However, even straight-grained wood bats will continue to fail; less so due to SOG failures, but will still fail from cracking, brash (shattering) and flaking The present invention will improve bat strength and reduce failures in all of these categories, including older wood bats with high SOGs. Marginal SOG bats (1:6 to 1:15) will be greatly strengthened with one or more wraps in the appropriate area.

Many other suggestions have been offered to reinforce and strengthen wood bats. Some other proposed methods to strengthen wooden bats are:

sliding and stationary metal collars,

fiberglass or composite wraps around handle area or whole bat,

laminations of various woods and composites,

metal rods through the center of bat,

plugs put into holes drilled in barrel,

and others.

There are four general types of wood bat failure: (1) rupture-type failure (cracking), (2) slope-of-grain failure (breaking, usually in two pieces), (3) brash failure (shattering), and (4) annual ring separation (splitting). Rupture and Slope-of-Grain are the most common failure types.

1. Rupture-type failure (cracking) of a baseball bat in the handle area is the type of failure that occurs when a straight-grained piece of wood is bent until it cracks or breaks.

2. Slope-of-grain failure (breaking) occurs when the slope of grain strength of a bat (usually the handle area) is less than the forces generated by the collision of the bat and ball. The wood fails along the grain and breaks into two pieces. The shear surface is shaped as an elongated oval.

3. Brash failure (shattering) in Maple bats is characterized by the shattering of the bat head (barrel) into multiple pieces. The culprit is thought to be the extra-drying of the maple wood, done to help reduce its weight. Less drying of the wood is expected to reduce this shattering tendency; however the bats will be heavier.

4. Annual Ring Separation occurs primarily in Ash bats which have been continually used to hit on the flat of the grain. This failure usually causes a thin piece of wood to separate along the grain from the barrel end.

Operation

New Bats: The wrap(s) is/are applied at the manufacturer's facility after the wood bat has been lathe-turned and sanded smooth. The bat should be very smooth and should contain no scratches, nicks, gouges, holes or any other abrasion where the bending forces generated by the bat/ball collision could concentrate and lead to wood failure and breakage;

Used Bats: The wraps can be applied to used bats in the field, where a portable wrapping machine is used. In either case of a new or a used wood bat, the wrapping machine provides tension on the thread as it is turning the bat, which tension amount is adjustable and is calculated to provide the maximum resistance to failure for that portion of the bat being wrapped. A bonding agent is used to permanently bond the applied threads to the wood of the bat.

Construction of the Invention

The wraps can be applied to the newly-made bat at the manufacturer's facility, using a proprietary tool setup, or the wraps can be applied in the field using a portable wrapping machine.

The diameter and tension of the wrapping thread, the location of the wrap(s), the number of turns in each wrap and the total number of wraps are determined individually for each bat, prior to wrapping.

In the portable wrapping unit, the bat is laid onto rollers with the intended wrap location aligned with the thread supply; the end of the thread is secured, either by being tucked under the next turn of thread or by an adhesive, the thread pulled tight in a specific tension, and the portable wrapping unit is turned on. The bat is held tightly against the two bat rollers by a third roller, which is aligned with the two bat rollers and which third roller holds the bat in compression using a clamp and screw adjuster. The thread tensioner is adjusted for the proper tension as the bat is turned and the thread is being applied to the bat.

The roller motor is gear-connected to the bat rollers and turns the bat slowly. The tensioned thread is guided to the correct spot on the bat by the operator while the bat continues to be turned by the roller, until the desired amount of turns of thread is applied. Depending on the desired effect and coverage, each turn is spaced tightly, loosely or widely from the other turns of that wrap. Before wrapping with the reinforcing thread wrap, a bonding agent is applied to the wooden bat at the location(s) where the threads will be wrapped. After the desired amount of turns has been applied, the operator applies said bonding agent over the tensioned threads, to make a permanent bond between the thread and the bat wood. The thread is then cut from the spool and the loose end is pulled tight, trimmed and then bonded to the batwood. Additional wraps, as desired, are completed on that bat in the same manner.

### BRIEF DESCRIPTION OF THE SEVERAL VIEWS OF THE DRAWINGS

FIG. 1 is a perspective view of a bat blank before being shaped into a bat. The bat-making process uses a wood lathe to turn the wood blank into the shape of a bat;

FIG. 2 is a plan view of a wood baseball bat showing constituent parts; (cup, head/barrel, taper, handle, knob, sweet spot/area, grip area).

FIG. 3 is a plan view of a wood baseball bat showing bat and ball forces at impact; (kinetic energy, bat & ball forces).

FIG. 4 is a plan view of a bat under which are aligned graphic representations of the first, second, and the third bending modes of the wood bat, indicating the relative vibrational proclivities of each mode.

FIG. 5 is a plan view of a wood bat showing off-node bending impact of ball/bat collision.

FIG. 6 is a perspective view of a broken wood bat showing a characteristic sign of failure due to a high slope of grain (SOG).

FIG. 7 is a perspective view of an idealized depiction of a bat being strengthened, with 1 wrap completed and one wrap in process.

### DETAILED DESCRIPTION OF THE INVENTION

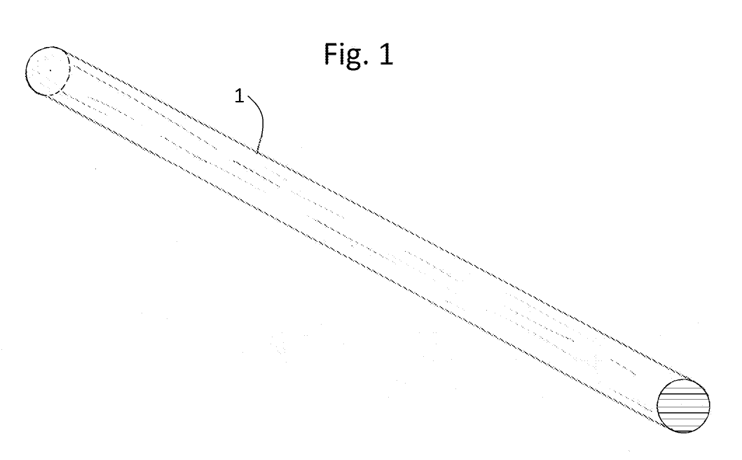

FIG. 1. FIG. 1 is a perspective view of a wooden bat blank 1, before being shaped into a bat. It is a single, solid piece of non-laminated and non-composite wood which is ready to be lathe-turned into a wooden baseball bat. This blank is shown after a square wood billet has been turned in a lathe until it is round in shape, and is a certain diameter along its length. Continued turning in a lathe enables the shaping of the blank into a bat.

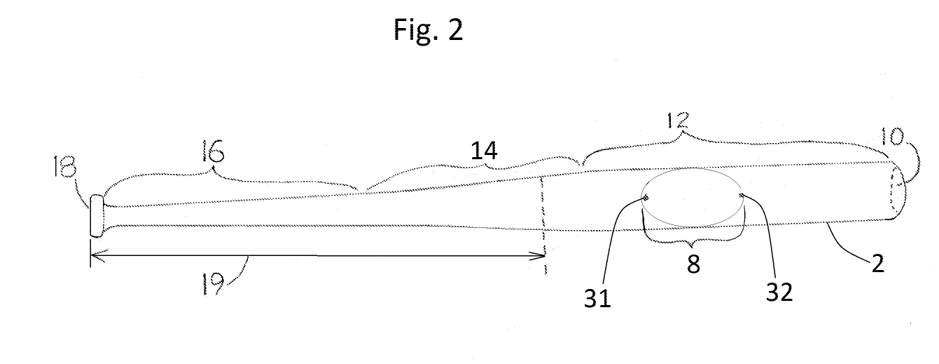

FIG. 2. FIG. 2 is a plan view of a wooden baseball bat 2 showing areas and names: cup 10, barrel 12, taper 14, handle 16, showing their approximate boundaries, and knob 18. Also shown is the sweet spot area 8, defined by the nodes of the first 31 and the second 32 bending modes of the bat wood. The grip area 19 is the 18 inch-long length of the handle of the bat where MLB rules allow the application of a grip enhancer, such as pine tar.

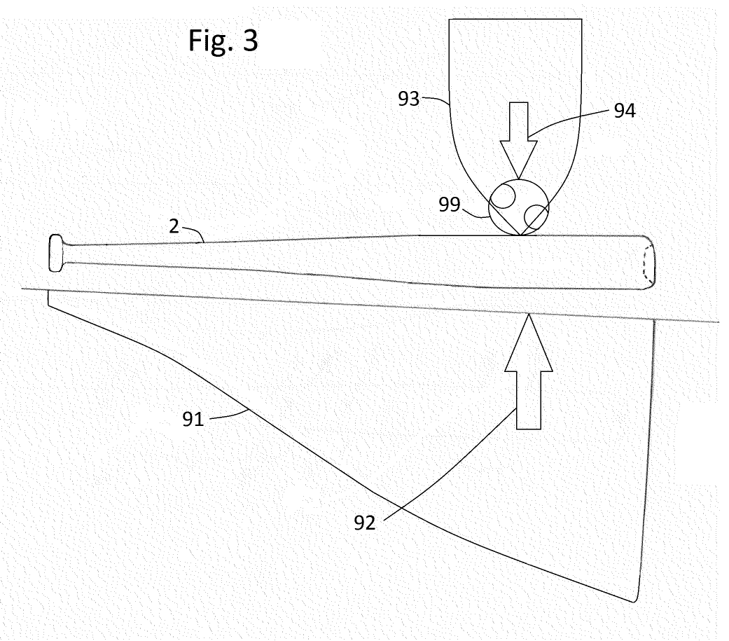

FIG. 3. FIG. 3 is a plan view of a wood baseball bat 2 showing kinetic forces at bat 2/ball 99 impact, including a graphic representation of bat momentum 91 along the length of the bat, and a graphic of the ball's momentum 93. Also shown is the locus of force of the bat 92, and the locus of force of the ball 94.

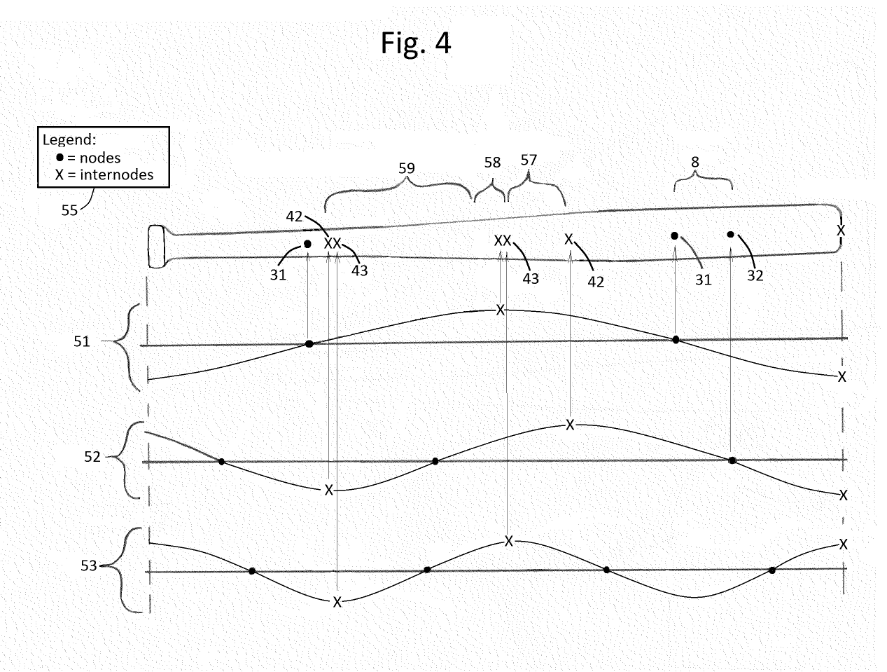

FIG. 4 FIG. 4 is a plan view of a bat 2 under which plan view are aligned graphic representations of the first 51, second 52, and the third 53 bending modes of the wood bat, indicating the relative vibrational characteristics of each mode. The nodes 31 and 32 are considered to define the general sweet spot area 8 where ball impact would absorb the least of the ball's 99 (FIG. 3) momentum and excite the least vibrations in the bat 2. The internodes 41, 42, and 43 indicate the area along the length of the bat where the bat will be maximally excited by ball impact. Also are indicated areas along the bat 2, of potential ball impact, where the probability of breakage is the greatest, indicated by “Danger zone,” 57, “Critical” 58 and “High Probability of Breakage” 59. Legend 55 shows that nodes are depicted with a dot (.) and internodes are depicted with an X.

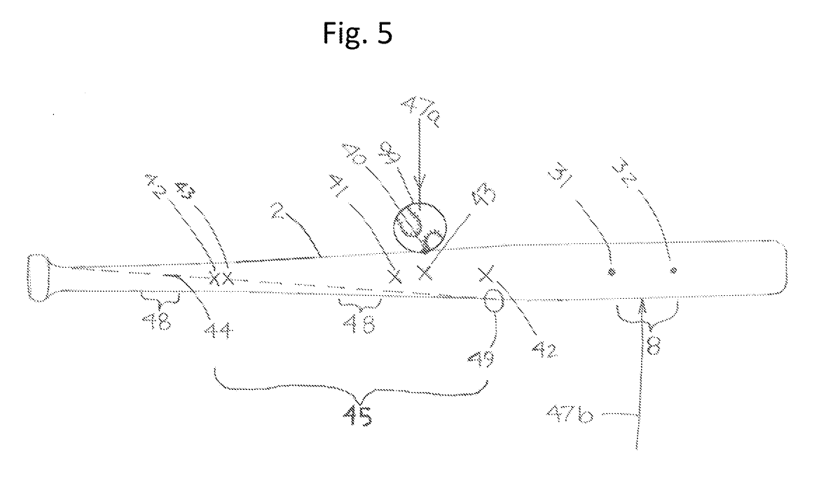

FIG. 5 FIG. 5 is a plan view of a wood bat 2 showing off-node bending impact of ball/bat collision. Ball 99 impact point 40 and center of relative ball momentum 47a are shown. Center of relative bat momentum 47b is shown. The first 41, second 42 and third 43 internodes of the bending modes are shown, which if struck in this area, will result in the most absorption of the ball's momentum and the greatest bending moment, greatest resultant bat vibration and greatest potential for breakage. The grain line 44 of a 1:20 slope of grain (SOG) is shown. The location of maximum shear and tension stress 49 on the bat's grain 44 and the proposed best locations for handle wraps 48 for this 1:20 SOG bat are also shown. The bracket 45 depicts the general area along the length of a wood bat where a ball impact would have the greatest probability of breaking the bat.

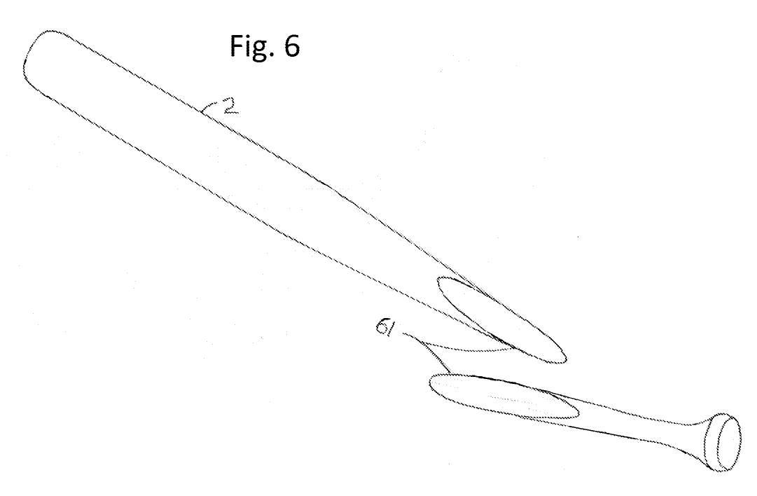

FIG. 6 FIG. 6 is a perspective view of both pieces of a broken wood bat 2 showing a characteristic sign of failure due to a high slope of grain (SOG). Note the elongated oval shape of the break area 61 shown on each of the broken pieces.

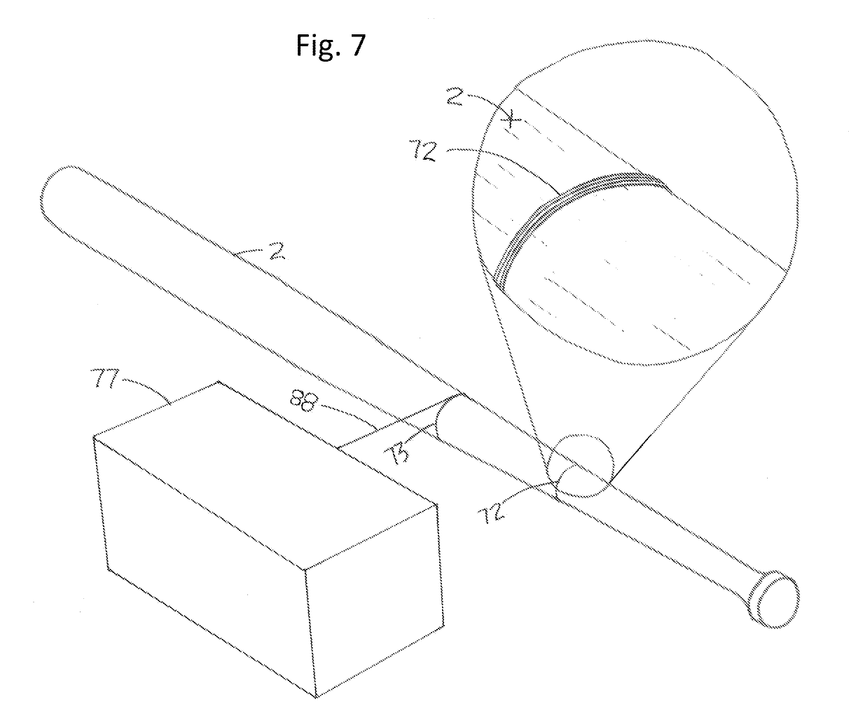

FIG. 7 FIG. 7 is an idealized perspective depiction of a bat in the process of being strengthened, showing various stages of a strengthening operation. A wood bat 2 shows a completed wrap 72, with an enlargement which shows the tiny strands of the high-strength thread, bonded to the wood bat 2, and a wrap in the process of being applied 73 by a wrapping machine 77, which machine applies a tension to the thread as the thread is being applied to the circumference of the bat. The high-strength thread 88 is shown applying the last wrap 73.

Materials used in this invention:

1. New or used wooden bat

2. High-strength thread made from para-aramid (Kevlar) fiber, carbon fiber or other high-strength fiber.

3. High-strength bonding agent.

Preferred parts for at least one embodiment of the invention:

1. New or used wooden bat

2. Thread—high-strength para-aramid thread, carbon fiber thread or other high-strength fiber thread, for encircling the bat, providing thereby a strong girdling support.

3. Bonding agent—for permanently bonding the wrap to the wood bat.

### DETAILED DESCRIPTION OF THE PREFERRED EMBODIMENTS

In at least one embodiment of the present invention, the tensioned wraps of thread, made from high-strength para-aramid fiber, carbon fiber or other high-strength fiber, encircle the bat in a relatively perpendicular arrangement with regard to the longitudinal axis of the bat; these said wraps of thread are tensioned during application and permanently bonded onto the bat at one or more locations along the length of the bat, where it is calculated and determined to be the location(s) which wrapping(s) would produce the greatest increase in strength for that bat, considering the bat's characteristics.

Although the invention has been shown and described with respect to a certain embodiment, equivalent and obvious alterations and modifications will occur to others skilled in the art upon reading and understanding this specification. The present invention includes all such alterations and modifications and is limited only by the scope of the invention as presented.

What is claimed is:

1. A reinforced wooden baseball bat comprising:
a single piece of round, solid, non-laminated and non-composite wood having a barrel portion of a certain diameter at a distal end, and a handle portion at a proximal end, with a tapered portion at the center between the two ends, the handle portion having a smaller diameter than the barrel portion;
one or more circumferentially arranged, tensioned turns of lightweight, high-strength fiber threads, such as para-aramid fiber (Kevlar), carbon fiber thread or other high-strength and lightweight thread, applied around and bonded to the bat, at a location or multiple locations along the length of the bat, which location(s) has or have been calculated and determined to maximize the overall bat strength and resistance of the bat to breaking

2. A reinforced wooden baseball bat of claim 1, which wrapped turns of thread are bonded to the bat using a permanent bonding agent with high impact strength and resistance.

3. A reinforced wooden baseball bat of claim 1, which is a hardwood, wherein the hardwood is among the group consisting of ash, beech, birch, elm, hickory, maple, and oak.

4. A reinforced wooden baseball bat of claim 1, wherein the solid wood bat is unmodified; that is to say that there has been no cutting, drilling or laminating of the bat, and the completed bat, before application of the wrap, has not been altered in any way.

5. A reinforced wooden baseball bat of claim 1, wherein the encircling strands of thread are tensioned during application to provide a pre-loaded centripetal force on the area of the bat where the wrap is placed, which centripetal force adds to the resistance of the wood in that area of the bat to cracking or breaking.

6. a reinforced wooden baseball bat of claim 1, whose wrapping turns are tightly, loosely or widely spaced along the length of the bat.

7. A method of reinforcing a wood baseball bat comprising:
a. providing a wooden baseball bat;
b. applying one or more wrappings to the bat of one or more circumferential tensioned turns of high-strength string or thread, such as para-aramid fiber (Kevlar), carbon filament or other high strength, lightweight fiber, at a location or multiple locations along the length of said wooden baseball bat where it is determined that said wrappings would provide the greatest increase in the strength of said bat;
c. permanently securing each applied wrap to the bat using a high-strength bonding agent.
